(19) United States
(12) Patent Application Publication
(10) Pub. No.: US 2017/0220763 A1
(43) Pub. Date: Aug. 3, 2017

(54) SYSTEM, METHOD, AND NON-TRANSITORY COMPUTER-READABLE STORAGE MEDIA FOR SECURE DISCRETE COMMUNICATION WITH PHARMACIST OF RETAIL STORE

(71) Applicant: Wal-Mart Stores, Inc., Bentonville, AR (US)

(72) Inventors: Justin Toupin, San Francisco, CA (US); Nathan Thomas Diepenbrock, Highlands Ranch, CO (US)

(21) Appl. No.: 15/009,583

(22) Filed: Jan. 28, 2016

(51) Int. Cl. G06F 19/00; G06Q 20/18; H04W 4/14

(52) U.S. Cl. CPC G06F 19/3456; G06F 19/322; H04W 4/14; G06Q 20/18

(57) ABSTRACT

A system, method, and non-transitory computer-readable storage media includes a computer system configured to receive input from and provide output on a mobile computer application for a retail store running on a mobile computing device of a customer. The computer system is also configured to allow the customer to discretely communicate through the mobile computer application with a pharmacist in a pharmacy of the retail store.

### COPYRIGHT NOTICE

The figures included herein contain material that is subject to copyright protection. The copyright owner has no objection to the facsimile reproduction by anyone of this patent document as it appears in the U.S. Patent and Trademark Office, patent file or records, but reserves all copyrights whatsoever in the subject matter presented herein.

### BACKGROUND OF THE INVENTION

1. Field of the Invention

U.S. Patent Classification Primary Class: 707 (DATA PROCESSING: DATABASE, DATA MINING, AND FILE MANAGEMENT OR DATA STRUCTURES). Art Unit: 2161.

The present invention relates generally to online transactional processing and communication and, more particularly, to a system, method, and non-transitory computer-readable storage media for secure discrete communication with a pharmacist in a pharmacy of a retail store.

2. Description of the Related Art

Many pharmacy consumers desire to obtain advice related to their general heath and the pharmaceutical medications being prescribed to them remotely, e.g., on-line, through the Internet, or using a specially designed application or app on a personal computer or mobile device, such as a tablet or cell phone. In addition, pharmacy customers that have a prescription for an “embarrassing condition” desire to ask questions and hear explanations from a pharmacist without people overhearing. For example, the customer may have a prescription for a sexual transmitted disease and would like to communicate with the pharmacist to ask questions about their prescription and condition. However, these customers may be reluctant to do so if their communications can be heard by others, especially in a pharmacy of retail store.

It is, therefore, desirable to provide a new system, method, and non-transitory computer-readable storage media that allows for secure discrete communication with a pharmacist in a pharmacy of a retail store. It is also desirable to provide a new system, method, and non-transitory computer-readable storage media that allows a customer to communicate with a pharmacist through a mobile application. It is further desirable to provide a new system, method, and non-transitory computer-readable storage media that provides communication between the customer and the pharmacist in a pharmacy of a retail store without other customers overhearing their conversation. Thus, there is a need in the art to provide a system, method, and non-transitory computer-readable storage media for secure discrete communication with a pharmacist in a retail store that meets at least one of these desires.

### SUMMARY OF THE INVENTION

In different embodiments of the present invention, systems, methods, and non-transitory computer-readable storage media are provided for generating, communicating, and displaying information to users via mobile computing devices.

Accordingly, the present invention provides a system including a computer system configured to receive input from and provide output to a mobile computer application for a retail store running on a mobile computing device of a customer. The computer system is also configured to allow the customer to discretely communicate the input and receive the output through the mobile computer application with a pharmacist in a pharmacy of the retail store.

In addition, the present invention provides a method including the steps of receiving, by a computer system, input from and provide output to a mobile computer application for a retail store running on a mobile computing device of a customer. The method also includes the steps of allowing the customer to discretely communicate the input and receive the output through the mobile computer application with a pharmacist in a pharmacy of the retail store.

Further, the present invention provides one or more non-transitory computer-readable storage media, having computer-executable instructions embodied thereon, wherein when executed by at least one processor cause the processor to receive input from and provide output to a mobile computer application for a retail store running on a mobile computing device of a customer. The computer-executable instructions also cause the processor to allow the customer to discretely communicate the input and receive the output through the mobile computer application with a pharmacist in a pharmacy of the retail store.

One advantage of the present invention is that a new system, method, and non-transitory computer-readable storage media is provided for secure discrete communication with a pharmacist in a pharmacy of a retail store. Another advantage of the present invention is that the system, method, and non-transitory computer-readable storage media allows a customer to communicate directly with a pharmacist through a mobile computer application, primarily by texting the pharmacist and having a conversation with him/her. Yet another advantage of the present invention is that the system, method, and non-transitory computer-readable storage media provides all communication through a mobile computer application of the retailer. Still another advantage of the present invention is that the system, method, and non-transitory computer-readable storage media provides a secure communication line between a communication server and a mobile computer application running on a mobile computing device for communication between the customer and the pharmacist.

Other features and advantages of the present invention will be readily appreciated, as the same becomes better understood, after reading the subsequent description taken in conjunction with the accompanying drawings.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a schematic illustrating various aspects of a system, according to the present invention.

FIG. 2 is a schematic illustrating example components of a server computer that may be used with the system shown in FIG. 1, according to an embodiment of the present invention.

FIG. 3 is an illustration of an exemplary screenshot from the system of FIG. 1, according to an embodiment of the present invention.

FIG. 4 is an illustration of exemplary database records generated by the system of FIG. 1, according to an embodiment of the present invention.

FIG. 5 is an illustration of an exemplary screenshot from the system of FIG. 1, according to an embodiment of the present invention.

FIGS. 6-9 is are illustrations of exemplary screenshots from the system of FIG. 1, according to an embodiment of the present invention.

FIG. 10 is a flowchart of a method that may be used with the system shown in FIG. 1, according to an embodiment of the present invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION OF THE PREFERRED EMBODIMENT(S)

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present invention may be embodied as an apparatus, system, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible media of expression having computer-usable program code embodied in the media.

Any combination of one or more computer-usable or computer-readable media (or medium) may be utilized. For example, a computer-readable media may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The flowchart and block diagrams in the flow diagrams illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable media that can direct a computer or other programmable data processing apparatus to function in a particular manner, such that the instructions stored in the computer-readable media produce an article of manufacture including instruction means which implement the function/act specified in the flowchart and/or block diagram block or blocks.

Several (or different) elements discussed below, and/or claimed, are described as being “coupled”, “in communication with”, or “configured to be in communication with”. This terminology is intended to be non-limiting, and where appropriate, be interpreted to include without limitation, wired and wireless communication using any one or a plurality of a suitable protocols, as well as communication methods that are constantly maintained, are made on a periodic basis, and/or made or initiated on an as needed basis. The term “coupled” means any suitable communications link, including but not limited to the Internet, a LAN, a cellular network, or any suitable communications link. The communications link may include one or more of a wired and wireless connection and may be always connected, connected on a periodic basis, and/or connected on an as needed basis.

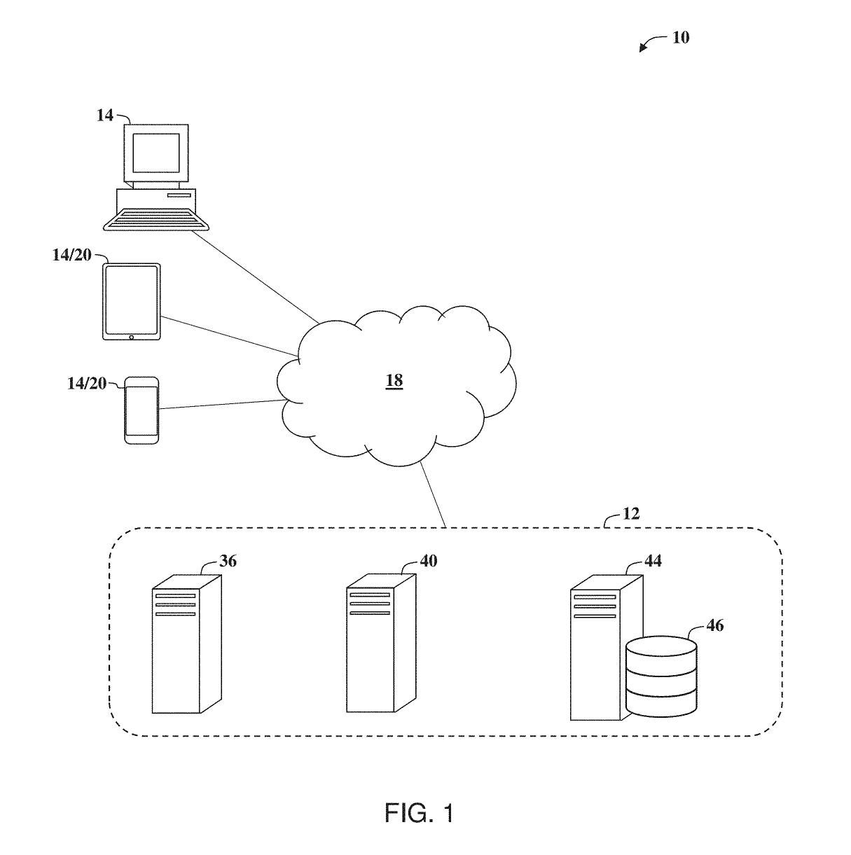

With reference to the FIGS. and in operation, the present invention provides a networked computer system 10, methods and computer product media that allows secure discrete communication with a pharmacist in a pharmacy of a retail store for pharmacy customers. Referring to FIG. 1, an exemplary environment in which the networked computer system 10 operates is illustrated. In general, the present invention describes a networked computer system 10 that allows communication for pharmacy customers using a mobile application running on a mobile device.

For clarity in discussing the various functions of the system 10, multiple computers and/or servers are discussed as performing different functions. These different computers (or servers) may, however, be implemented in multiple different ways such as modules within a single computer, as nodes of a computer system, etc. . . . The functions performed by the system 10 (or nodes or modules) may be centralized or distributed in any suitable manner across the system 10 and its components, regardless of the location of specific hardware. Furthermore, specific components of the system 10 may be referenced using functional terminology in their names. The function terminology is used solely for purposes of naming convention and to distinguish one element from another in the following discussion. Unless otherwise specified, the name of an element conveys no specific functionality to the element or component.

In the illustrated embodiment, the system 10 includes a server system 12 that is coupled in communication with one or more user computing devices 14 via a communications network 18. The communications network 18 may be any suitable connection, including the Internet, file transfer protocol (FTP), an Intranet, LAN, a virtual private network (VPN), cellular networks, etc. . . . , and may utilize any suitable or combination of technologies including, but not limited to wired and wireless connections, always on connections, connections made periodically, and connections made as needed. It should be appreciated that, in some embodiments, the server system 12 may communicate over a separate private network, rather than over a common network.

The user computing device 14 may include any suitable device that enables a user to access and communicate with the system 10 including sending and/or receiving information to and from the system 10 and displaying information received from the system 10 to a user. For example, in one embodiment, the user computing device 14 may include, but is not limited to, a desktop computer, a laptop or notebook computer, a tablet computer, smartphone/tablet computer hybrid, a personal data assistant, a handheld mobile device including a cellular telephone, and the like. The user computing device 14, as well as any other connected computer systems and their components included in the system 10, can create message related data and exchange message related data (e.g., near field communication (“NFC”) payloads, Bluetooth packets, Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the communications network 18.

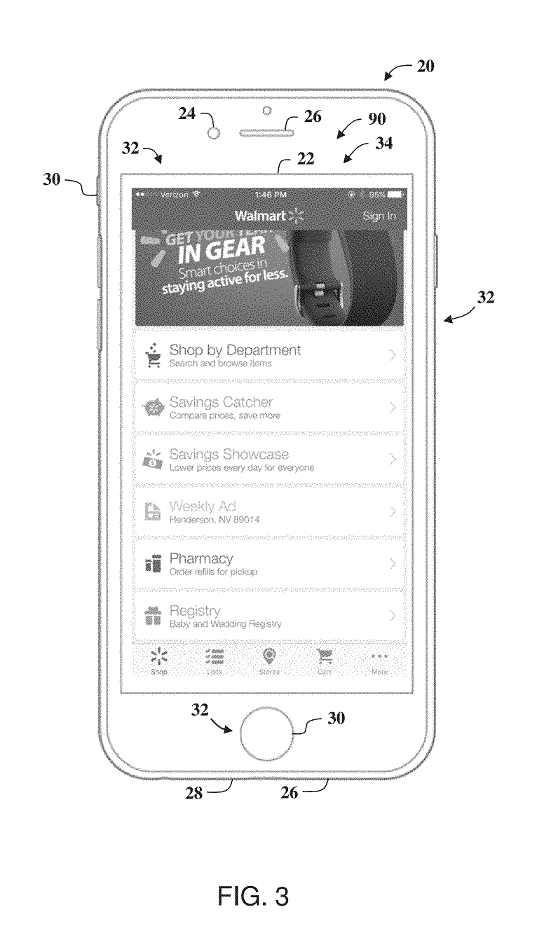

In one embodiment, the user computing device 14 includes a mobile computing device 20 (shown in FIG. 3) such as, for example, a smartphone such as an iPhone™. The mobile computing device 20 includes a processor coupled to a memory device, and a database for storing various programs and data for use in operating the mobile computing device 20. The mobile computing device 20 may also include a touchscreen display device 22, one or more video image cameras 24, one or more speakers 26, a microphone 28, at least one input button 30, and one or more sensors 32 including, but not limited to, a touch ID fingerprint sensor coupled to the input button 30, a barometer, a three-axis gyro, an accelerometer, proximity sensor, and an ambient light sensor. In addition, the mobile computing device 20 may also include a Wi-Fi antenna, a cellular network antenna, a Bluetooth™ communications device, assisted GPS and GLONASS, a digital compass, and an iBeacon microlocation device. In another embodiment, the user computing device 14 may be a kiosk having one or more of the components of the mobile computing device 20.

In the illustrated embodiment, the mobile computing device 20 includes a web browser program stored in the memory device. The processor executes the web browser program to display web pages on the touchscreen display device 22 that includes information received from the server system 12 to enable a user to interact with and operate the server system 12. In addition, the mobile computing device 20 may be programmed to store and execute computer program applications that display user interfaces 34 (shown in FIGS. 3 and 6-9) on the touchscreen display device 22 that allows the user to access the server system 12 to retrieve and store information within the server system 12 as well as interact with and operate the server system 12. In addition, in one embodiment, the system 10 may install one or more mobile computer application programs in the memory device of the mobile computing device 20. When initiated by the processor of the mobile computing device 20, the mobile computer application program causes the processor of the mobile computing device 20 to perform some or all of the functions of the server system 12.

In the illustrated embodiment of FIG. 1, the server system 12 includes a website hosting server 36, a pharmacy account or communications server 40, a database server 44, and a database 46. The database server 44 includes a memory device that is connected to the database 46 to retrieve and store information contained in the database 46. The database 46 contains information on a variety of matters, such as, for example, web pages associated with one or more websites, search queries, pharmaceutical drug information, refill information, entity authentication information, customer pharmacy account information, product records, notification messages, mobile device identifies, mobile device application program interfaces (APIs), and/or any suitable information that enables the system 10 to function as described herein. In one embodiment, some or all of the information contained in the database 46 may also be stored in the database of the mobile computing device 20.

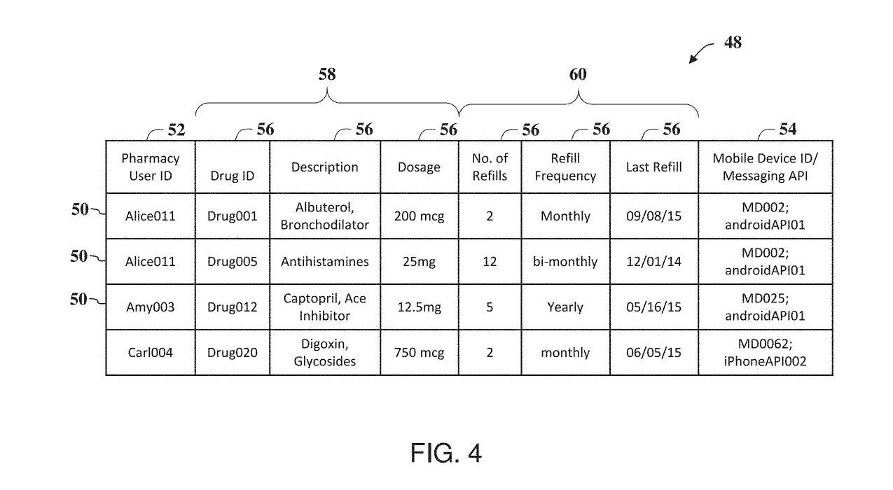

In the illustrated embodiment, the database 46 includes a pharmacy account list 48 (shown in FIG. 4) that includes a plurality of user pharmacy account records 50. Each user pharmacy account record 50 is associated with a corresponding pharmacy customer and includes user identification information 52 associated with the pharmacy customer and pharmaceutical drug data associated with pharmaceutical drugs prescribed to and/or purchased by the corresponding pharmacy customer. The user identification information 52 includes user identifying data such as, for example, a unique user ID and/or password. The user identification information 52 may also include user contact information such as, for example, a phone number, an email, and/or a mobile device data 54 associated with a mobile computing device 20 associated with the corresponding pharmacy customer. For example, the mobile device data 54 may include, but is not limited to, a unique mobile device ID, operating system, phone number, IP address, mobile device API, and/or any suitable information that enables the system 10 to communicate with the corresponding mobile computing device 20.

In the illustrated embodiment, each user pharmacy account record 50 includes a plurality of data categories 56 associated with the pharmaceutical drugs prescribed to and/or purchase by the pharmacy customer. The data categories 56 includes information associated with the pharmaceutical drugs and activities associated with the pharmacy customers. For example, in one embodiment, each user pharmacy account record 50 may include a first data group 58 including data categories 56 including information associated with a corresponding pharmaceutical drug and a second data group 60 including data categories including information indicating pharmacy customer activities associated with the corresponding pharmaceutical drug. The first data group 58 may include data categories 56 including information indicating a unique drug ID associated with the pharmaceutical drug, pharmaceutical drug description, drug category, prescribed use information, dosage information, and/or any suitable information associated with the corresponding pharmaceutical drug. The second data group 60 may include data categories 56 including information indicating a number of refills remaining, a refill frequency, a date and/or time of the last refill purchase, purchase date, and/or prescription expiration, and/or any suitable information associated with pharmacy customer activity.

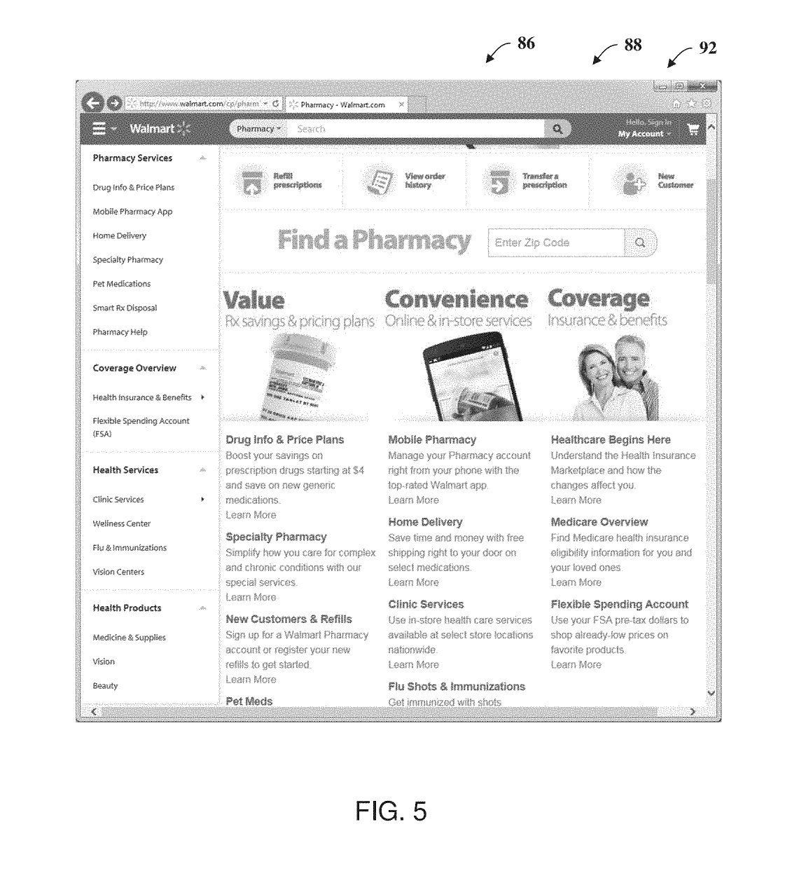

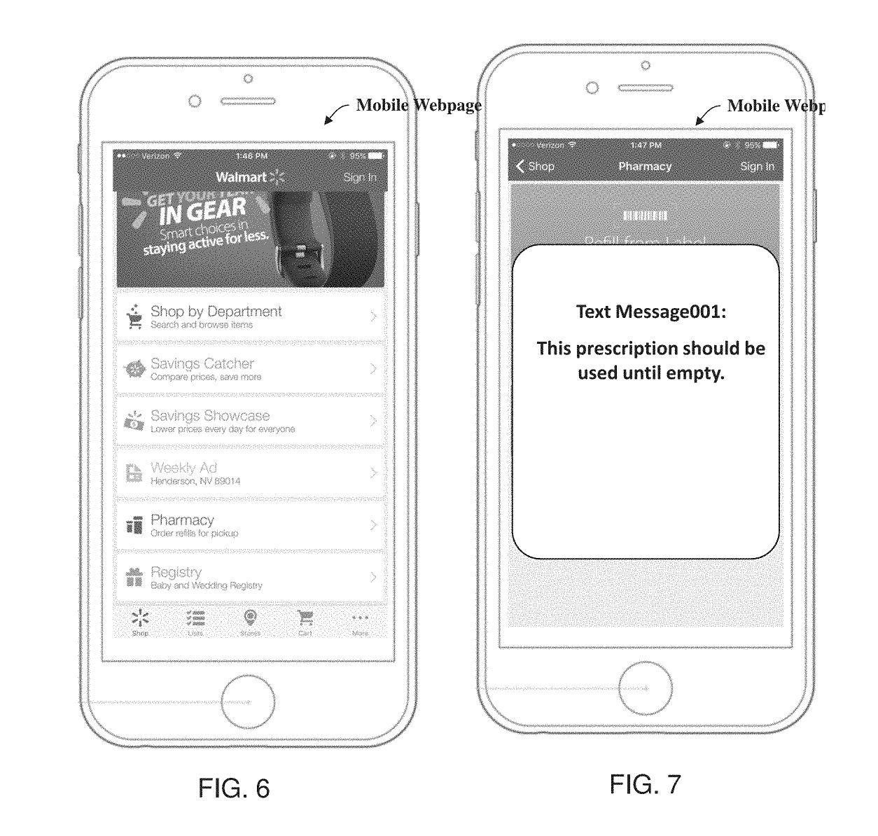

The website hosting server 36 is configured to host a website 86 that is accessible by a user via one or more user computing devices 14. The website hosting server 36 retrieves and stores web pages 88 (shown in FIG. 5) associated with one or more websites 86 in response to requests received by the user via the user computing device 14 to allow users to interact with the website and search and/or purchase products such as, for example, goods and/or services via the website. In one embodiment, the website hosting server 36 is configured to generate and display web pages 88 associated with the website in response to requests being received from consumers or customers via corresponding web browsers that are displayed on the user computing devices 14. In addition, the website hosting server 36 may be configured to generate and display a mobile webpage 90 (shown in FIGS. 3 and 6-9) that is displayed on one or more mobile computing devices 20. For example, in one embodiment, the website hosting server 36 may display a pharmacy webpage 92 (shown in FIGS. 6-9) in response to receiving a user request that allows a user to access a corresponding user pharmacy account record 50, input product search requests including search criteria including one or more search terms, purchase pharmaceutical drugs, request prescription refills, request pharmacist consultations, schedule pharmacy and/or medical clinic appointments, and the like.

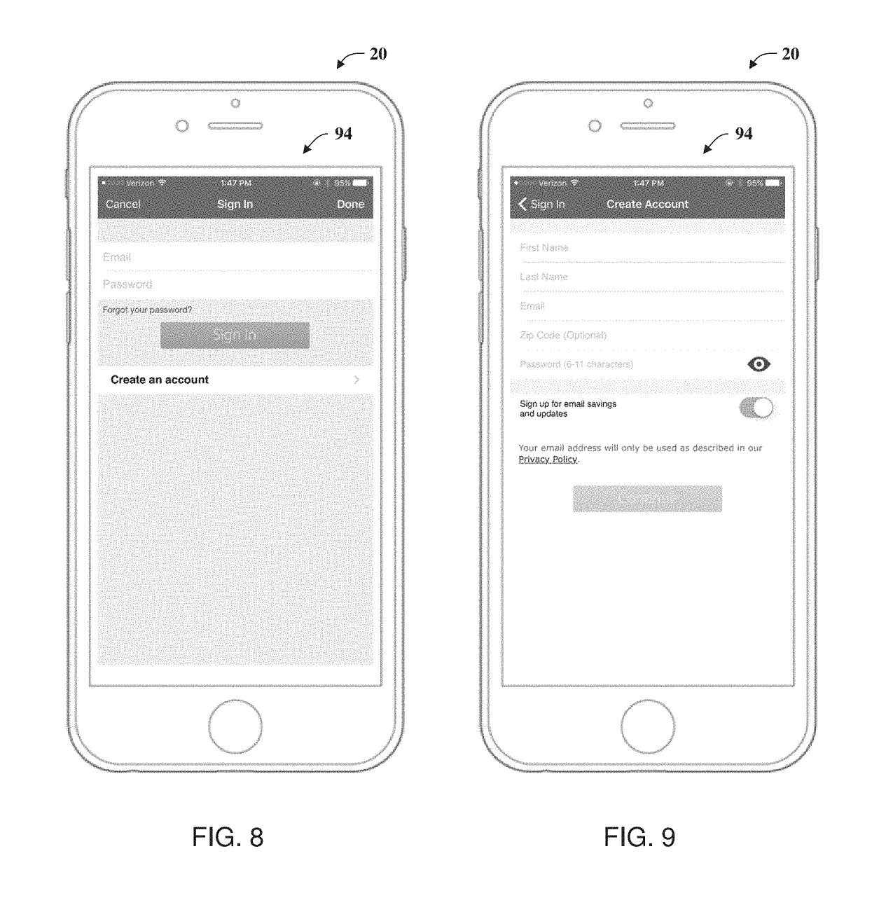

The website hosting server 36 may allow customers to login and access corresponding customer pharmacy accounts including account information such as, for example, previous purchases, pending proscription orders, pending medication refills, and/or pharmaceutical drug information. For example, the website hosting server 36 may display a login page 94 (shown in FIGS. 8-9), receive a unique customer ID such as, for example, a username and/or password, and identify the customer account associated with the unique customer ID to enable the identified customer to access information and/or features associated with the corresponding customer pharmacy account or to communicate with a pharmacist directly in a pharmacy of a retail store.

In the illustrated embodiment, the pharmacy communication server 40 accesses the pharmacy account list 48 and selects a user pharmacy account record 50 associated with the user ID received in the request to communicate. In one embodiment, the request may include a mobile device ID. The pharmacy communication server 40 may identify a user pharmacy account record 50 that includes a mobile device ID matching the received mobile device ID. In one embodiment, the pharmacy communication server 40 may access the user identification information 52 to retrieve the user identifying data associated with the pharmacy customer and generate an encrypted message to securely transmit communication to the mobile computing device 20.

In one embodiment, the pharmacy communication server 40 may also access the user pharmacy account record 50 associated with the user ID, retrieve contact information associated with the corresponding pharmacy customer, and transmit a verification message to the pharmacy customer based on the retrieved contact information. The verification message may include a verification hyperlink including verification data that allows the pharmacy customer to access the hyperlink and transmit a verification signal to the pharmacy communication server 40. For example, in one embodiment, the user pharmacy account record 50 may include an email address and/or a phone number associated with a phone capable of received SMS text messages. The pharmacy communication server 40 may generate the verification message 100 including an email message and/or SMS text message and transmit the email message and/or SMS text message including the verification hyperlink to the pharmacy customer.

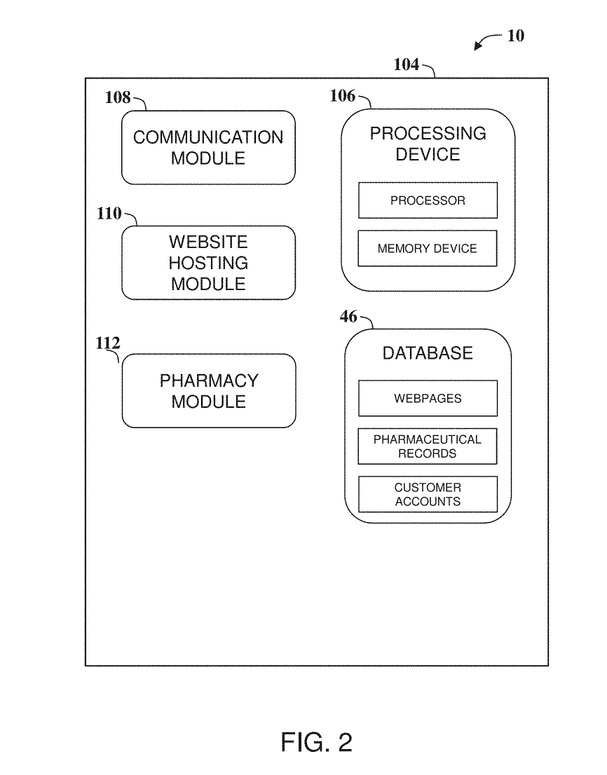

Referring to FIG. 2, in one embodiment, the system 10 may include a system server 104 that is configured to perform the functions of the website hosting server 36, the pharmacy communication server 40, and the database server 44. In the illustrated embodiment, the system server 104 includes a processing device 106 and the database 46.

The processing device 106 executes various programs, and thereby controls components of the system server 104 according to user instructions received from the user computing device 14. The processing device 106 may include memory, e.g., read only memory (ROM) and random access memory (RAM), storing processor-executable instructions and one or more processors that execute the processor-executable instructions. In embodiments where the processing device 106 includes two or more processors, the processors can operate in a parallel or distributed manner. In an example, the processing device 106 may execute a communications module 108, a website hosting module 110, and a pharmacy module 112.

The processing device 106 may also include a memory device for storing programs and information in the database 46, and retrieving information from the database 46 that is used by the processor to perform various functions described herein. The memory device may include, but is not limited to, a hard disc drive, an optical disc drive, and/or a flash memory drive. Further, the memory device may be distributed and located at multiple locations.

The communications module 108 retrieves various data and information from the database 46 and sends information to the user computing device 14 via the communications network 18 to enable the user to access and interact with the system 10. In one embodiment, the communications module 108 displays various images on a graphical interface of the user computing device 14 preferably by using computer graphics and image data stored in the database 46 including, but not limited to, web pages, pharmacy records, pharmacy notification messages, pharmacy communications, product lists, and/or any suitable information and/or images that enable the system 10 to function as described herein.

The website hosting module 110 may be programmed to perform some or all of the functions of the website hosting server 36 including hosting various web pages associated with one or more websites that are stored in the database 46 and that are accessible to the user via the user computing device 14. The website hosting module 110 may be programmed to generate and display web pages associated with a website in response to requests being received from users via corresponding web browsers.

The pharmacy module 112 may be programmed to perform some or all of the functions of the pharmacy communication server 40 including monitoring activities associated with pharmacy customers including consumer purchase and/or proscription refill requests, generate notification messages associated with the monitored activities, transmit and received data from 3^{rd} party entity server systems, and executing verification and authorization operations.

In addition, the system 10 includes a user computing device 14 for the pharmacist in the pharmacy of the retail store. The user computing device 14 for the pharmacist interacts with the server system 12 to allow the pharmacist to communicate with the pharmacy communication server 40 and, in turn, with the user computing devices 14 and the mobile computing devices 20 of the customers.

Other features of the system 10 can be found in the following commonly owned US Patent Applications, which are hereby incorporated by reference: U.S. patent application Ser. No. N/A, filed on Jan. 28, 2016 (Attorney Docket Number068571.00242); U.S. patent application Ser. No. N/A, filed on Jan. 28, 2016 (Attorney Docket Number 068571.00243); U.S. patent application Ser. No. N/A, filed on Jan. 28, 2016 (Attorney Docket Number 068571.00244); U.S. patent application Ser. No. N/A, filed on Jan. 28, 2016 (Attorney Docket Number 068571.00245); U.S. patent application Ser. No. N/A, filed on Jan. 28, 2016 (Attorney Docket Number 068571.00246); U.S. patent application Ser. No. N/A, filed on Jan. 28, 2016 (Attorney Docket Number 068571.00247); U.S. patent application Ser. No. N/A, filed on Jan. 28, 2016 (Attorney Docket Number 068571.00249); U.S. patent application Ser. No. N/A, filed on Jan. 28, 2016 (Attorney Docket Number 068571.00250); U.S. patent application Ser. No. N/A, filed on Jan. 28, 2016 (Attorney Docket Number 068571.00251); U.S. patent application Ser. No. N/A, filed on Jan. 28, 2016 (Attorney Docket Number 068571.00252); and, U.S. patent application Ser. No. N/A, filed on Jan. 28, 2016 (Attorney Docket Number 068571.00253).

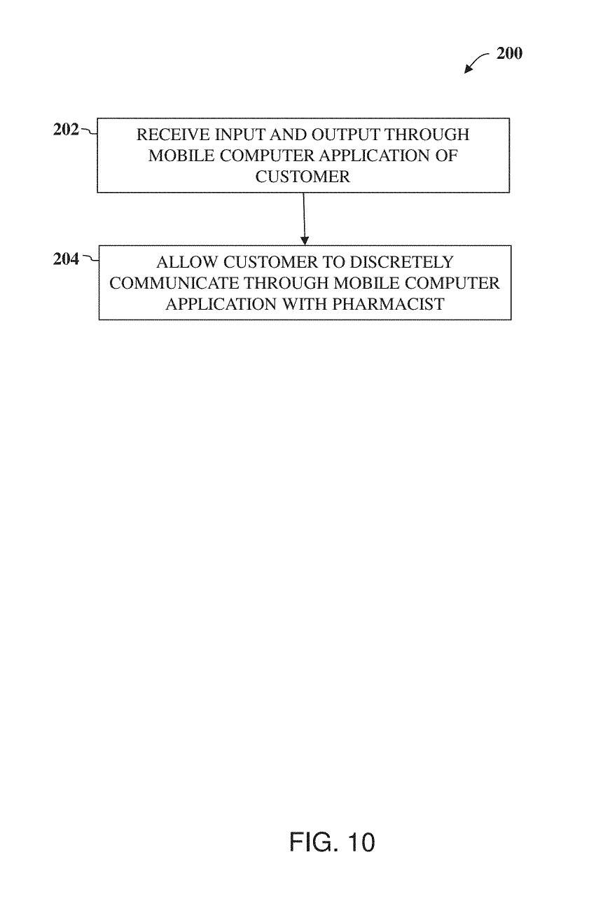

FIG. 10 is a flowchart of a method 200 that may be used with the system 10 for secure discrete communication with a pharmacist in a pharmacy of a retail store for pharmacy customers. The method includes a plurality of steps. Each method step may be performed independently of, or in combination with, other method steps. Portions of the methods may be performed by any one of, or any combination of, the components of the system 10. FIGS. 8-9 are exemplary graphical displays that may be displayed by the system 10.

The method includes the steps of providing a pharmacy communication server 40 to transmit and receive communications to and from the user computing device 14 and/or the mobile computing device 20 of a pharmacy customer. For example, the pharmacy communication server 40 and the mobile computing device 20 communicate with each other over the network 18. The method includes the steps of providing a secure communication line between the pharmacy communication server 40 and the mobile computer application running on the mobile computing device 20 for communication between the pharmacy customer and the pharmacist in the pharmacy of the retail store. For example, the secure communication line may be the network 18 and, in one embodiment, the network 18 is a private network. In addition, the communications may be encrypted over the network 18 to provide a secure communication line between the pharmacy communication server 40 and the user computing device 14 of the pharmacist and the mobile computing device 20 of the customer. It should be appreciated that there are other methods of providing a secure communication line between the pharmacy communication server 40 and the user computing device 14 and the mobile computer application running on the mobile computing device 20 for communication between the pharmacy customer and the pharmacist in the pharmacy of the retail store.

The method includes the steps of providing a mobile computing device 20 by the pharmacy customer. For example, the pharmacy customer typically has a mobile computing device 20 that is used for communication in general. In one embodiment, the method includes the step of providing the mobile computing device 20 as a smart phone or tablet. For example, the mobile computing device may be an IPhone™ or IPad™. In another embodiment, the method includes the step of providing the user computing device 14 or the mobile computing device 20 as a kiosk. For example, the mobile computing device 20 may be a communication device such as a touch screen at a kiosk to allow communication to the pharmacist in the pharmacy of the retail store. It should be appreciated that the pharmacist in the pharmacy of the retail store has a user computing device 14 with a communication module such as a computer, smart phone, or tablet.

In the illustrated embodiment, in method step 202, the pharmacy communication server 40 is configured to receive input from and provide output to a mobile computer application for a retail store running on the mobile computing device 20 of the pharmacy customer. For example, the mobile computer application may be a pharmacy application as illustrated in FIGS. 6-9. In method step 204, the pharmacy communication server 40 is configured to allow the customer to discretely communicate the input and receive the output through the mobile computer application with a pharmacist in a pharmacy of the retail store. For example, the pharmacy customer logs into their pharmacy account with the mobile computer application by inputting a user ID and user Password. Once the pharmacy communication server 40 and database server 46 verify the user ID and user Password of the pharmacy customer, the mobile computer application allows input and output through the mobile computer application between the pharmacy customer and the pharmacist. In one embodiment, the method includes the steps of texting the communication by the customer on the mobile computing device 20. For example, the pharmacy customer uses a texting function on their mobile computing device 20 to send and receive a text message between the pharmacy customer and the pharmacist. In another embodiment, the method includes the steps of instant messaging the communication by the customer on the mobile computing device 20. For example, the pharmacy customer uses an instant messaging function on their mobile computing device 20 to send and receive an instant message between the pharmacy customer and the pharmacist. It should be appreciated that the pharmacist sends and receives text messages and instant messages through the user computing device 14 in the pharmacy of the retail store.

The method also includes the steps of conducting all communication through the mobile computer application. For example, the pharmacy customer cannot remotely communicate with the pharmacist except through the mobile computer application running on their mobile computing device 20. In one embodiment, the method further includes the steps of providing the name of the customer as part of the communication. For example, the customer inputs their name into the mobile computer application running on their mobile computing device 20 to allow proper greetings between the pharmacy customer and the pharmacist. In another embodiment, the method also includes the step of providing the location of the retail store as part of the communication. For example, the customer inputs the location of the retail store, for example “6800 Oak Drive” into their mobile computer application running on their mobile computing device 20 to allow the pharmacy communication server 40 to properly direct the communication to the pharmacist of that particular retail store.

The method also includes the step of transmitting a communication to the mobile computing device 20 of the customer for display by the mobile computer application. For example, transmitting, by the computer system 10, a communication to the mobile computing device 20 and the mobile computer application running on the mobile computing device 20 provides the customer with information. The method includes the step of displaying with the mobile computer application running on the mobile device 20 the communication. For example, the mobile computer application displays the communication from the pharmacist such as “This prescription should be used until empty” on the display of the mobile computing device 20 of the pharmacy customer as illustrated in FIG. 7. The method ends. It should be appreciated that the method includes other steps such as providing the computer system and servers and coupling the servers to one another.

A controller, computing device, server or computer, such as described herein, includes at least one or more processors or processing units and a system memory (see above). The controller typically also includes at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

In some embodiments, a database, as described herein, includes any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term database. Examples of databases include, but are not limited to only including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of

Microsoft Corporation, Redmond, Wash.; and Sybase is a registered trademark of Sybase, Dublin, Calif.).

The present invention has been described in an illustrative manner. It is to be understood that the terminology, which has been used, is intended to be in the nature of words of description rather than of limitation.

Many modifications and variations of the present invention are possible in light of the above teachings. Therefore, within the scope of the appended claims, the present invention may be practiced other than as specifically described.

What is claimed is:

1. A system comprising:
a computer system configured to receive input from and provide output to a mobile computer application for a retail store running on a mobile computing device of a customer;
the computer system being configured to allow the customer to discretely communicate the input and receive the output through the mobile computer application with a pharmacist in a pharmacy of the retail store.

2. A system as set forth in claim 1 wherein said computer system includes a communication server to transmit and receive communications to and from the mobile computing device of a customer.

3. A system as set forth in claim 2 wherein said computer system includes a secure communication line between the communication server and the mobile computer application on the mobile computing device for communication between the customer and the pharmacist.

4. A system as set forth in claim 1 wherein the communication comprises texting.

5. A system as set forth in claim 1 wherein the communication comprises instant messaging.

6. A system as set forth in claim 1 wherein the mobile computing device comprises a smart phone or tablet.

7. A system as set forth in claim 1 wherein the mobile computing device comprises a kiosk.

8. A system as set forth in claim 1 wherein all communication is conducted through the mobile computer application.

9. A system as set forth in claim 8 wherein the name of the customer is provided as part of the communication.

10. A system as set forth in claim 8 wherein the location of the retail store is provided as part of the communication.

11. A method comprising the steps of:
receiving, by a computer system, input from and provide output to a mobile computer application for a retail store running on a mobile computing device of a customer; and
allowing the customer to discretely communicate the input and receive the output through the mobile computer application with a pharmacist in a pharmacy of the retail store.

12. A method as set forth in claim 11 including the steps of providing a communication server to transmit and receive communications to and from the mobile computing device of the customer.

13. A method as set forth in claim 11 including the steps of providing a secure communication line between the communication server and the mobile computer application on the mobile computing device for communication between the customer and the pharmacist in the retail store.

14. A method as set forth in claim 11 including the steps of texting the communication by the customer on the mobile computing device.

15. A method as set forth in claim 11 including the steps of instant messaging the communication by the customer on the mobile computing device.

16. A method as set forth in claim 11 including the steps of providing the mobile computing device comprises a smart phone or tablet.

17. A method as set forth in claim 11 including the steps of providing the mobile computing device as a kiosk.

18. A method as set forth in claim 11 including the steps of conducting all communication through the mobile computer application.

19. A method as set forth in claim 18 including the steps of providing the name of the customer as part of the communication.

20. A method as set forth in claim 18 including the steps of providing the location of the retail store as part of the communication.

21. One or more non-transitory computer-readable storage media, having computer- executable instructions embodied thereon, wherein when executed by at least one processor, the computer-executable instructions cause the processor to:
receive input from and provide output to a mobile computer application for a retail store running on a mobile computing device of a customer; and
allow the customer to discretely communicate the input and receive the output through the mobile computer application with a pharmacist in a pharmacy of the retail store.
